(19) United States
(12) Patent Application Publication
(10) Pub. No.: US 2008/0130914 A1
(43) Pub. Date: Jun. 5, 2008

(54) Noise reduction system and method

(75) Inventor: Jung Kwon Cho, Seoul (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: INCEL VISION INC.

(21) Appl. No.: 11/790,206

(22) Filed: Apr. 24, 2007

Related U.S. Application Data
(60) Provisional application No. 60/745,579, filed on Apr. 25, 2006.

(51) Int. Cl. H04B 15/00

(52) U.S. Cl. 381/94.1

(57) ABSTRACT

A noise reduction system and a noise reduction method are provided. The noise reduction method estimates directions of arrival of signals by directly using a signal subspace of the signals. Noise of the signals is suppressed at directions other than the directions of arrival. In one embodiment, the signals include audio signals. The signals may be multiple wide-band signals and/or coherent signals in multipath environment with a low signal-to-noise ratio.

### CROSS REFERENCE TO RELATED APPLICATION

This application claims the benefit of priority from U.S. Provisional Patent Application Ser. No. 60/745,579 entitled “Enhanced Voice Quality System in Microphone Array Using Signal Vector Space for Cellular Phones (DMB/Video Conference Phones), Voice Input Systems for PC, PDA and Other Small Electronic Devices, Walkie Talkies (Nextel), Audio Recording Systems, Automobile Voice Command System, Hearing Aids and Robotic Voice Command Applications,” filed Apr. 25, 2006, the entire content of which is expressly incorporated herein by reference.

### TECHNICAL FIELD

The present invention generally relates to noise reduction techniques and, more particularly, to systems and methods for reducing noise of signals detected by a linear detector array.

### BACKGROUND

Linear microphone arrays have been employed as audio signal detector for portable communication devices, such as cellular phones, walkie-talkies, and the like. When a user converses with another using the portable communication device, linear microphone array detects audio signals articulated by the user so as to transmit detected audio signals to a receiving party. However, while detecting the articulated audio signals, a linear microphone array also detects noise signals omnipresent in the environment. In order to improve the quality of audio signals transmitted to the receiving party, noise signals present in detected audio signals need to be suppressed.

Typically, a linear microphone array often comprises a plurality of microphones that are linearly arranged and equally spaced. Microphones of the linear microphone array detect audio signals simultaneously. Audio signals detected by the microphones at one time snap, or in one snapshot, are gathered together and represented by a snapshot vector. Snapshot vectors can be used to precisely estimate directions of arrival (DOA) of detected audio signals.

For example, a multiple signal classification (MUSIC) algorithm has been developed by Ralph O. Schmidt (“Multiple Emitter Location and Signal Parameter Estimation,” IEEE Transactions on Antennas and Propagation, Vol. AP-34, No. 3, Pages 276-280, 1986) to estimate the DOA of narrow-band signals received by an array of sensors.

In general, a MUSIC algorithm constructs a spectral density matrix from one snapshot vector, and performs eigen-decomposition of the spectral density matrix to obtain eigenvalues and eigenvectors of the spectral density matrix. The MUSIC algorithm then uses the eigenvalues and eigenvectors to compute a spatial spectrum of the DOA, thereby estimating the DOA.

Due to the miniaturization of modern portable communication devices, microphones of a linear microphone array are separated only by a small distance. Audio signal sources and linear microphone array are also separated by a very short distance. For example, microphones in a modern portable communication devices may be separated by two centimeters, while the distance between a linear microphone array and audio signal source may be shorter than ten centimeters.

Under the above miniaturization conditions, audio signals may be reflected among microphones and/or between the linear microphone array and audio signal sources. Such reflection of audio signals may give rise to a multi-path condition, which may render audio signals coherent. However, a MUSIC algorithm often fails to precisely estimate the DOA of coherent audio signals.

One way to overcome the limitation of the MUSIC algorithm under the multi-path condition is to use a spatial smoothing method proposed by T. J. Shan et al. (“Adaptive Beamforming for Coherent Signals and Interference,” IEEE Transactions on Acoustics, Speech, and Signal Processing, Vol. ASSP-33, No. 3, Pages 527-536, 1985). However, although the spatial smoothing method can be used to estimate the DOA of coherent signals, it requires the linear microphone array to include a large number of microphones, which gives rise to a spatial spectrum with lower resolution.

Moreover, a MUSIC algorithm is limited to processing narrow-band signals, because the MUSIC algorithm employs only one snapshot vector. In order to extend MUSIC algorithm to handle wide-band or broad-band signals, many snapshot vectors need to be employed.

### SUMMARY

In one exemplary embodiment, there is provided a noise reduction system. The noise reduction system may include an input unit, a first converter, a signal processor, a second converter, and an output unit. The input unit may include a linear detector array for detecting analog signals at a plurality of time snaps, thereby constructing analog signals in time domain. The first converter is coupled with the input unit for receiving the analog signals in time domain and transforming the analog signals in time domain into digital signals in time domain. The signal processor is coupled with the first converter for receiving the digital signals in time domain. The signal processor further includes a transformation unit for converting the digital signals in time domain into digital signals in frequency domain; a noise suppression unit for suppressing noise in the digital signals in frequency domain by multiplying a weighting vector to the digital signals in frequency domain, thereby obtaining noise reduced digital signals in frequency domain; and an inverse transformation unit for converting the noise reduced digital signals in frequency domain into noise reduced digital signals in time domain. The second converter is coupled with the signal processor for receiving the noise reduced digital signals in time domain and transforming the noise reduced digital signals in time domain into noise reduced analog signals in time domain. The output unit may output the noise reduced analog signals in time domain.

In another exemplary embodiment, there is provided a noise reduction process. The noise reduction process may reduce noise in audio signals detected by a linear microphone array. The process may include the steps of preparing a plurality of snapshot vectors from the audio signals; constructing a covariance matrix from the snapshot vectors, and constructing a spectral density matrix from the covariance matrix; eigendecomposing the spectral density matrix to obtain a plurality of eigenvectors and a plurality of eigenvalues, thereby obtaining a signal subspace and a noise subspace; estimating DOA of the audio signals by a spatial spectrum derived from directly using the signal subspace; preparing a weighting vector based on the DOA; obtaining noise reduced audio signals using the weighting vector; and outputting the noise reduced audio signals.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### DESCRIPTION OF THE DRAWINGS

The accompanying drawings, which constitute a part of this specification, illustrate various embodiments and aspects consistent with the present invention and, together with the description, explain the principles of the invention.

FIG. 1 illustrates a linear microphone array for receiving audio signals from a signal source and a noise source.

FIGS. 2A and 2B respectively illustrate a three-dimensional covariance matrix and a three-dimensional spectral density matrix constructed from a plurality of snapshot vectors.

FIG. 3 illustrates the roots of a polynomial composed of eigenvectors of the noise space in a complex plane.

FIG. 4 illustrates the roots of a polynomial composed of eigenvectors of the signal space in a complex plane.

FIG. 5 illustrates a noise reduction system consistent with the invention.

FIG. 6 illustrates a noise reduction process consistent with the invention.

FIG. 7 illustrates the amplitudes of three model signal sources according to a computer simulation consistent with the invention.

FIG. 8 illustrates a spatial spectrum of weakly correlated signals according to a computer simulation using a covariance algorithm.

FIG. 9 illustrates a spatial spectrum of intermediately correlated signals according to a computer simulation using the covariance algorithm.

FIG. 10 illustrates a spatial spectrum of coherent signals according to a computer simulation using the covariance algorithm.

FIG. 11 illustrates a spatial spectrum of coherent signals according to a computer simulation using a Direct Usage of Signal Subspace (DUSS) algorithm.

### DETAILED DESCRIPTION

Reference will now be made in detail to examples consistent with the invention illustrated in the accompanying drawings. The implementations set forth in the following description are merely some examples consistent with certain aspects related to the invention, and do not represent all possible implementations consistent with the claimed invention. Wherever possible, the same reference numerals will be used throughout the drawings to refer to the same or like parts.

The following descriptions explain a noise reduction system and a noise reduction process for reducing noise in signals detected by a linear detector array. In one embodiment, the linear detector array may be a linear microphone array, and the detected signals may be audio signals. Although audio signals and linear microphone array are described, it is to be understood that other types of signals, such as electromagnetic radiation signals, and other types of linear detector arrays, such as a linear antenna array, may also be used.

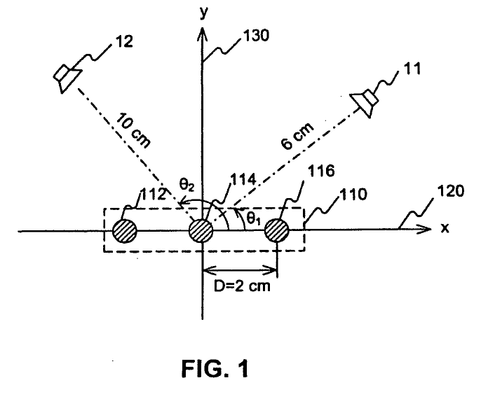

Referring now to FIG. 1, a linear detector array 110 includes a plurality of detectors linearly arranged and equally spaced between one another. In one embodiment, linear detector array 110 may include three detectors 112, 114, and 116. It is to be understood that, in other embodiments, linear detector array 110 may include any arbitrary number of detectors.

In one embodiment, detectors 112, 114, and 116 may include microphones for detecting audio signals. For convenience of description, detectors 112, 114, and 116 are configured to be positioned in a two dimensional plane, which is characterized by a horizontal axis 120 and a vertical axis 130 perpendicular to horizontal axis 120. Horizontal axis 120 crosses vertical axis 120 to define an origin.

As shown in FIG. 1, detector 114 is located at the origin; detector 112 is located on horizontal axis 120 and to the left of detector 114; and detector 116 is located on horizontal axis 120 and to the right of detector 114. Detectors 112, 114, and 116 are equally spaced between each other by a separation distance D. In one embodiment, separation distance D may be approximately two centimeters. Linear detector array 110 is configured to receive wide-band analog signals.

Because the wide-band analog signals received by linear detector array 110 may include noise signals, to simulate the received wide-band analog signals, a signal source 11 may be employed to produce signals intended to be received by linear detector array 110, and a noise source 12 may be employed to produce signals not intended to be received by linear detector array 110, as shown in FIG. 1. The signals intended to be received together with the signals not intended to be received constitute and simulate the wide-band analog signals received by linear detector array 110. In one embodiment, the wide-band analog signals include audio signals.

Signal source 11 may be a user's mouth, which produces audio signals articulated by the user. In one embodiment, signal source 11 may be located approximately six centimeters away from linear detector array 110 at a first angle θ₁ with respect to a positive direction of horizontal axis 120. It is appreciated that signal source 11 may include any other sound generators that produce audio signals intended to be detected by linear detector array 110.

Noise source 12, on the other hand, may be a speaker that produces noise signals, that is, any audio signals not intended to be detected by linear detector array 110, such as background music. In one embodiment, noise source 12 may be located approximately ten centimeters away from linear detector array 110 at a second angle θ₂ with respect to the positive direction of horizontal axis 120. It is appreciated that noise source 12 may be any other sound generators that produce audio signals not intended to be detected by linear detector array 110.

Although only signal source 11 and noise source 12 are shown in FIG. 1, it is to be understood that more than one signal source 11 and/or noise source 12 may exist in the neighborhood of linear detector array 110. For example, linear detector array 110 may include M detectors for detecting or inputting audio signals from P sound generators, where M and P are positive integers. The P sound generators may include signal source 11 and/or noise source 12. The P sound generators produces analog signals to be detected by linear detector array 110.

The analog signals detected by the i-th detector of linear detector array 110 at a time snap t may constitute an input signal yᵢ(t),

$${y}_{i} ( t ) = {\sum }_{j = 1}^{P} {a}_{i} ( {θ}_{j} , t ) ⊗ {u}_{j} ( t ) + {n}_{i} ( t ) , \qquad Equation 1$$

where aᵢ(θⱼ,t) denotes an impulse response of the i-th detector (1≦i≦M) for the j-th sound generator (1≦j≦P) with DOA at the j-th angle θⱼ and at time snap t; uⱼ(t) denotes the analog signals produced by the j-th sound generator at time snap t; nᵢ(t) denotes noise signals detected by the i-th detector at time snap t; and ⊕ denotes a convolution operation. By using all the M input signals yᵢ(t) at time snap t, one may construct a snapshot vector y(t), i.e.,

y(t)=A(t) ⊕u(t)+n(t), Equation 2

where y(t) and n(t) are M×1 column vectors of the input signals and the noise signals, respectively, u(t) is a P×1 column vector of the generated analog signals, and A(t) is a P×M matrix of the impulse response. More specifically,

$$\begin{matrix}{\underline{y}}^{T} ( t ) = [ {y}_{1} ( t ) , … , {y}_{M} ( t ) ] , & Equation 3 \\ {\underline{n}}^{T} ( t ) = [ {n}_{1} ( t ) , … , {n}_{M} ( t ) ] , & Equation 4 \\ {\underline{u}}^{T} ( t ) = [ {u}_{1} ( t ) , … , {u}_{P} ( t ) ] , and & Equation 5 \\ \begin{matrix}A ( t ) = [ \underline{a} ( {θ}_{1} , t ) , … , \underline{a} ( {θ}_{P} , t ) ] \\ = [ \begin{matrix}{a}_{1} ( {θ}_{1} , t ) & … & {a}_{1} ( {θ}_{P} , t ) \\ ⋮ & ⋰ & ⋮ \\ {a}_{M} ( {θ}_{1} , t ) & … & {a}_{M} ( {θ}_{P} , t )\end{matrix} ] ,\end{matrix} & Equation 6\end{matrix}$$

where T in Equations 3-5 denotes a transpose operation of a vector or a matrix.

Next, one may perform Z-transformation on snapshot vector y(t) of Equation 2 to obtain a Z-transformed snapshot vector y(Z),

y(Z)=A(Z)u(Z)+n(Z), Equation 7

where A(Z)=[a(θ₁,Z), . . . , a(θₚ,Z)], and Z is a complex number represented as Z=exp(Jφ), where J is an imaginary unit number defined as the square root of minus one, and φ is an azimuthal angle of the complex plane. By using Z-transformed snapshot vector y(Z) given in Equation 7, one may construct a spectral density S(Z),

S(Z)=E[y(Z)y^{T}(Z⁻¹)]=A(Z)E[u(Z)u^{T}(Z⁻¹)]A^{T}(Z⁻¹)+E[n(Z)n^{T}(Z⁻¹)], Equation 8

where E[•] denotes an expectation value. Spectral density S(Z) includes a signal (noise free) spectral density and a noise spectral density. In terms of Z=exp(Jφ), Equation 8 may be expressed as

S(φ)=S_{NF}(φ)+ρ_{w}Σ(φ), Equation 9

where S_{NF}(φ) is the signal (noise free) spectral density, Σ(φ) is the noise spectral density, and ρ_{w} is a proportionality constant.

To compute eigenvectors and eigenvalues of Z-transformed spectral density S(φ) given in Equation 9, one may eigen-decompose Z-transformed spectral density S(φ) by multiplying Σ^{-1/2}(φ) to the left of spectral density S(φ) and (Σ^{-1/2}(φ))^{H} to the right of spectral density S(φ), where Σ^{-1/2}(φ) is an inverse of the square root of noise spectral density E(φ), and (Σ^{-1/2}(φ))^{H} is a Hermitian conjugate of Σ^{-1/2}(φ). Accordingly, an eigen-decomposed spectral density is obtained, i.e.,

Σ^{-1/2}(φ)S(φ)(Σ^{-1/2}(φ))^{H}=Σ^{-1/2}(φ)S_{NF}(φ)(Σ^{-1/2}(φ))^{H}+ρ_{w}I, Equation 9

where I is an identity matrix. Because Σ^{-1/2}(φ)S(φ)(Σ^{-1/2}(φ))^{H} has a rank of P, one may obtain P non-zero eigenvalues, which are denoted as Λ_{P}(φ), and (M−P) zero eigenvalues. Eigenvectors corresponding to the P non-zero eigenvalues constitute a signal subspace, while eigenvectors corresponding to the (M−P) zero eigenvalues constitute a noise subspace. In addition, eigen-decomposed spectral density may give rise to a normalized eigenvector E(φ), namely E(φ)E^{H}(φ)=I. Accordingly, one obtains,

$${Σ}^{- 1 / 2} ( φ ) {S}_{NF} ( φ ) {( {Σ}^{- 1 / 2} ( φ ) )}^{H} = E ( φ ) [ \begin{matrix}{Λ}_{P} ( φ ) & 0 \\ 0 & 0\end{matrix} ] {E}^{H} ( φ ) . \qquad Equation 10$$

### Equation 9 can thus be rewritten in terms of eigenvalues Λ_{P}(φ) and eigenvector E(φ), i.e., Σ^{-1/2}(φ)S(φ)(Σ^{-1/2}(φ)^{H}=E(φ)Λ(φ)E^{H}(φ), where

$$Λ ( φ ) = [ \begin{matrix}{Λ}_{P} ( φ ) + {ρ}_{w} I & 0 \\ 0 & {ρ}_{w}\end{matrix} ] .$$

### Here, eigenvalues Λ_{P}(φ) include eigenvalues of signal source 11 and noise source 12.

Based on Equation 10, Z-transformed signal spectral density S_{NF}(φ) and a Z-transformed signal spectral factor S_{NF}^{1/2}(φ) may be obtained, i.e.,

S_{NF}(φ)=Σ^{1/2}(φ)E_{P}(φ)Λ_{P}(φ)E^{H}(φ)(Σ^{1/2}(φ))^{H}, and Equation 11

S_{NF}^{1/2}(φ)=Σ^{1/2}(φ)E_{P}(φ)Λ_{P}^{1/2}(φ), Equation 12

where E_{P}(φ) is the eigenvector including P elements corresponding to the P non-zero eigenvalues. By performing inverse Fourier transform on Z-transformed signal spectral density S_{NF}(φ) and spectral factor S_{NF}^{1/2}(φ) given in Equations 11 and 12, one may obtain a signal spectral density S_{NF}(Z) and a signal spectral factor S_{NF}^{1/2}(Z),i.e.,

$$\begin{matrix}{S}_{NF} ( Z ) = {\sum }_{k = - ∞}^{∞} {Z}^{- k} \frac{1}{2 π} {\int }_{- π}^{π} d φ {S}_{NF} ( φ ) exp [ Jk φ ] , and & Equation 13 \\ {S}_{NF}^{1 / 2} ( Z ) = {\sum }_{k = - ∞}^{∞} {Z}^{- k} \frac{1}{2 π} {\int }_{- π}^{π} d φ {S}_{NF}^{1 / 2} ( φ ) exp [ Jk φ ] . & Equation 14\end{matrix}$$

Signal spectral density S_{NF}(Z) in Equation 13 may be computed by interpolating points on a unit circle using a moving average model. In one embodiment, 2n+1 points may be used on the unit circle, and signal spectral density S_{NF}(Z) may be uniquely determined by Lagrange interpolation, i.e.,

$${S}_{NF} ( Z ) = {\sum }_{i = - n}^{n} {b}_{i} ( Z ) {S}_{i} , \qquad Equation 15$$

where Sₗ is a spectral density matrix (S₋ₗ=Sₗ^{T}), bₗ(Z) is an interpolation function defined as

$${b}_{i} ( Z ) = \frac{1}{2 n + 1} {\sum }_{k = - n}^{n} {( {W}^{i} )}^{k} {Z}^{k} , \\ and Z = {W}^{i} = exp [ J 2π \frac{1}{2 n + 1} i ] .$$

The interpolation points may be uniformly placed in the unit circle to estimate the signal subspace. By eigen-decomposing signal spectral density S_{NF}(Z) given in Equation 15, one may obtain eigenvalues and eigenvectors of signal spectral density S_{NF}(Z), thereby estimating the dimension of the signal subspace.

Euclidean distance d(θ) between the noise subspace and a directional vector is defined as,

$${d}^{2} ( θ ) = {\sum }_{i = - n}^{n} {f}_{i} {‖ {\underline{a}}_{i}^{H} ( θ ) {E}_{ic} ‖}^{2} , \qquad Equation 16$$

where E_{lc} is a noise subspace matrix comprised of column eigenvectors of a noise subspace, aₗ^{H}(θ) is a directional vector to be discussed, and fₗ is a spectral weighting function (ƒₗ>0) also to be discussed. The spatial spectrum of the DOA may be defined as

$$\begin{matrix}{P}_{CV} ( θ ) = \frac{1}{{d}^{2} ( θ )} \\ = \frac{1}{{f}_{0} {‖ {\underline{a}}_{0}^{H} ( θ ) {E}_{0 c} ‖}^{2} + 2 {\sum }_{i = 1}^{n} {f}_{i} {‖ {\underline{a}}_{i}^{H} ( θ ) {E}_{ic} ‖}^{2}} .\end{matrix} \qquad Equation 17$$

In order to precisely estimate DOA for multiple wide-band audio signals and coherent signals in multi-path environment, a plurality of snapshot vectors at various time snaps may be employed to construct a covariance matrix. In one embodiment, Q snapshot vectors are considered, where Q is a positive integer. The q-th snapshot vector is given as

g^{T}(q)=[y₁(q), . . . , y_{M}(q)], Equation 18

where 1≦q≦Q. Using a plurality of snapshot vectors defined in Equation 7, one may construct a covariance matrix Rₖ, which is given as

$${R}_{k} = \frac{1}{Q - k} {\sum }_{q = k + 1}^{Q} \underline{g} ( q ) {\underline{g}}^{T} ( q - k ) = \\ \frac{1}{Q - k} [ \begin{matrix}{\sum }_{q = k + 1}^{Q} {y}_{1} ( q ) {y}_{1} ( q - k ) & … & {\sum }_{q = k + 1}^{Q} {y}_{1} ( q ) {y}_{M} ( q - k ) \\ ⋮ & ⋰ & ⋮ \\ {\sum }_{q = k + 1}^{Q} {y}_{M} ( q ) {y}_{1} ( q - k ) & … & {\sum }_{q = k + 1}^{Q} {y}_{M} ( q ) {y}_{M} ( q - k )\end{matrix} ] \qquad Equation 19$$

where R₋ₖ=Rₖ^{T} with subscript k being an integer ranging from −n to n, and Q=2n+1 (n is an arbitrary integer).

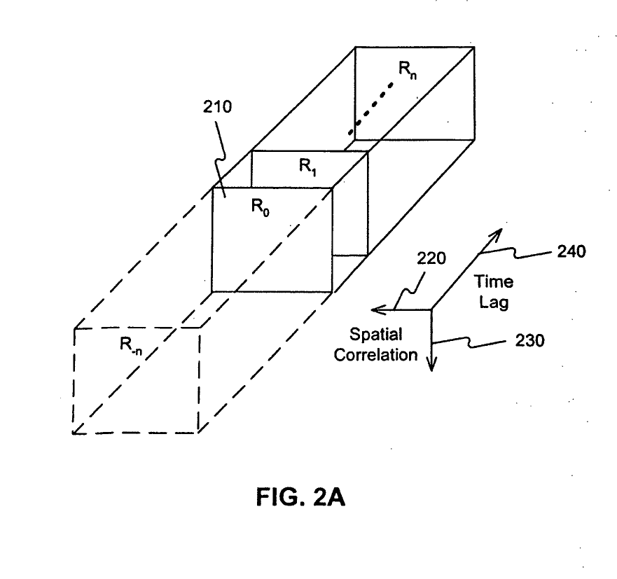

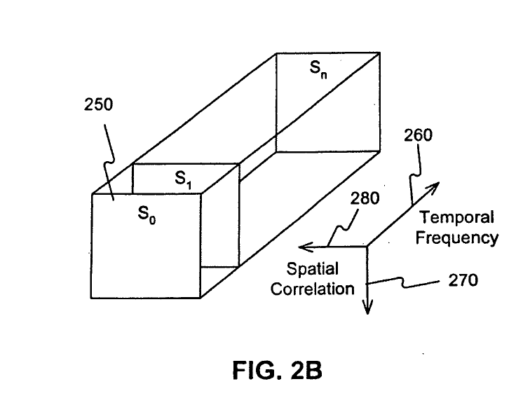

FIG. 2A schematically illustrates a plurality of covariance matrices Rₖ along a time lag direction 240. As shown, each covariance matrix Rₖ is symbolized by a square 210, which represents spatial correlations spanned in a first axis 220 and a second axis 230. In one embodiment, Q snapshot vectors are used to construct 2n+1 covariance matrices Rₖ.

Using Equation 19, one may define spectral density matrix Sₗ as

$${S}_{l} = {\sum }_{k = - n}^{n} w ( k ) {R}_{k } Exp [ - J 2 π \frac{l}{2 n + 1} k ] , ( 0 \leq l \leq n ) \qquad Equation 20$$

where w(k) is a weighting vector. Eigenvalues and eigenvectors of n+1 spectral density matrices Sₗ may be obtained by eigen-decomposing spectral density matrices Sₗ. Using eigenvalues and eigenvectors of spectral density matrices Sₗ, one may distinguish and identify the signal subspace and the noise subspace. If noise subspace matrix E_{lc} comprises (M−P) eigenvectors of the noise subspace, spatial spectrum P_{CV}(θ) may be computed using Equation 17 without considering the direct current (DC) component (i.e. the l=0 term). Spectral weighting function ƒₗ may then be defined as

$${f}_{l} = \frac{1}{n} ,$$

if unweighted, and

$${f}_{l} = {\sum }_{i = 1}^{P} {λ}_{li} ,$$

if weighted, where λₗᵢ are eigenvalues for the signal subspace. In addition, directional vector aₗ(θ) is given as

aₗ^{T}(θ)=[1, exp(J2π), . . . , exp(J2π(M−1)k)], Equation 21

where

$$k = \frac{Dl sin θ}{2 n + 1} ,$$

and D is the separation distance between two detectors of linear detector array 110. Directional vector aₗ(θ) may be a complex sinusoid vector to be used to compute Euclidean distance d(θ) with a signal subspace and/or a noise subspace.

FIG. 2B schematically illustrates a plurality of spectral density matrices Sₗ along a temporal frequency direction 260. As shown, each spectral density matrix Sₗ is symbolized by a square 250, which represents spatial correlations spanned in a first axis 270 and a second axis 280. In one embodiment, spectral density matrices Sₗ may be constructed from covariance matrices Rₖ.

In order to precisely estimate the DOA for coherent signals and to overcome the deficiencies of the spatial smoothing method, one may compute the spatial spectrum by direct usage of the signal subspace (DUSS).

The Z-transformed noise subspace may be expressed as,

$$\begin{matrix}{T}_{k} ( Z ) = {\sum }_{n = 1}^{M} {\underline{v}}_{k} ( n ) {Z}^{- ( n - 1 )} \\ = {Y}_{k} ( Z ) {\prod }_{i = 1}^{P} [ 1 - exp [ - J {ω}_{i} ] {Z}^{- 1} ] ,\end{matrix} \qquad Equation 22$$

where vₖ(n) denotes the n-th component of the k-th eigenvector of the noise subspace, Yₖ(Z) denotes a Z-polynomial of (M−P) components, and ωᵢ denotes an incident angle parameter. Incident angle parameter ωᵢ, which may be defined as ωᵢ=2πf₀D sin θᵢ/c, includes incident angle information of the i-th sound generator at center frequency f₀.

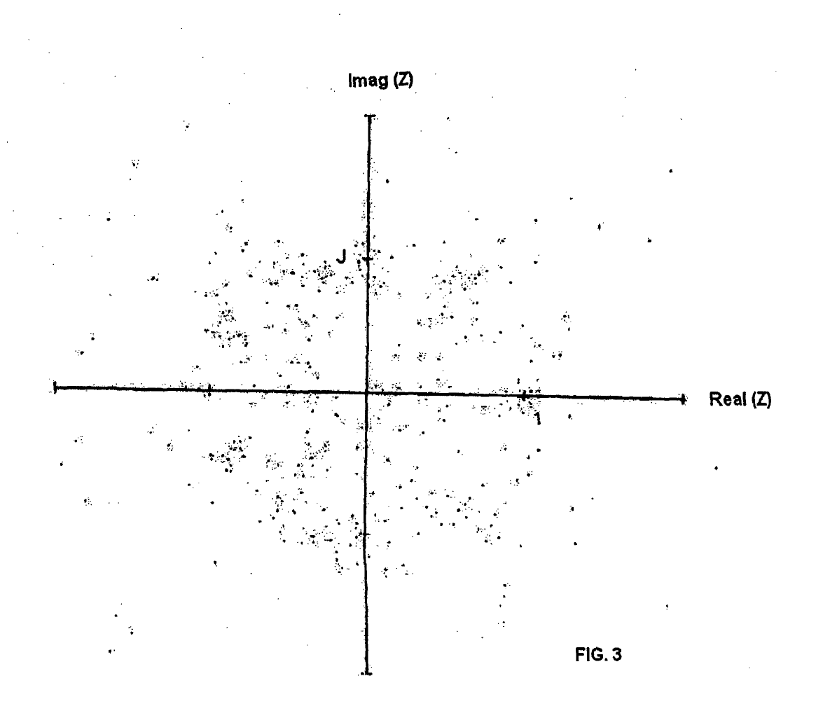

In one embodiment, the roots of polynomials Tₖ(Z) are computed for three coherent signals (i.e. P=3) and eight detectors (i.e. M=8) with a signal-to-noise ratio (SNR) being 10 dB. The roots of polynomials Tₖ(Z) are complex numbers, which can be represented as dots in a complex plane. As shown in FIG. 3, the dots representing roots of polynomials Tₖ(Z) are uniformly scattered within the unit circle of the complex plane. The uniformly scattered roots of polynomials Tₖ(Z) suggest that the signal subspace should be used to estimate the DOA for coherent signals.

Consider a spatial correlation matrix Uₖₗ, which comprises a plurality of columns corresponding to eigenvectors vₖ(l) of non-zero eigenvalues, and a null vector h corresponding to the eigenvector vₖ(l) of zero eigenvalues, an inner product of spatial correlation matrix Uₖₗ and null vector h must be zero and satisfy a homogeneous matrix equation, i.e.

Uₖₗh=0, Equation 23

where spatial correlation matrix Uₖₗ is a (M−K+1)×K matrix and null vector h is a K×1 column vector. If the inner product of spatial correlation matrix Uₖₗ and null vector h is not zero, then vector h is not a null vector of eigenvectors of spatial correlation matrix Uₖₗ. For simplicity, eigenvectors vₖ(l) is denoted as v(•), and spatial correlation matrix Uₖₗ is given as

$${U}_{kl} = [ \begin{matrix}v ( K ) & v ( K - 1 ) & … & v ( 1 ) \\ v ( K + 1 ) & v ( K ) & … & v ( 2 ) \\ ⋮ & ⋮ & ⋰ & ⋮ \\ v ( M ) & v ( M - 1 ) & … & v ( M - K + 1 )\end{matrix} ] . \qquad Equation 24$$

In order to compute for null vector h, one may perform eigen-decomposition to an inner product Fₖ of spatial correlation matrix Uₖₗ. Inner product Fₖ is defined as

$${F}_{k} = {\sum }_{j = 1}^{P} {U}_{kl}^{H} {U}_{kl} = {\sum }_{j = 1}^{P} [ \begin{matrix}{\sum }_{j = 0}^{M - K} {v}^{*} ( i + K ) v ( i + K ) & … & {\sum }_{j = 0}^{M - K} {v}^{*} ( i + K ) v ( i + 1 ) \\ ⋮ & ⋰ & ⋮ \\ {\sum }_{j = 0}^{M - K} {v}^{*} ( i + 1 ) v ( i + K ) & … & {\sum }_{j = 0}^{M - K} {v}^{*} ( i + 1 ) v ( i + 1 )\end{matrix} ] \qquad Equation 25$$

where P is a real dimension of spatial correlation matrix, K is a parameter determined by using the rule of thumb, and v*(•) is a complex conjugate of v(•).

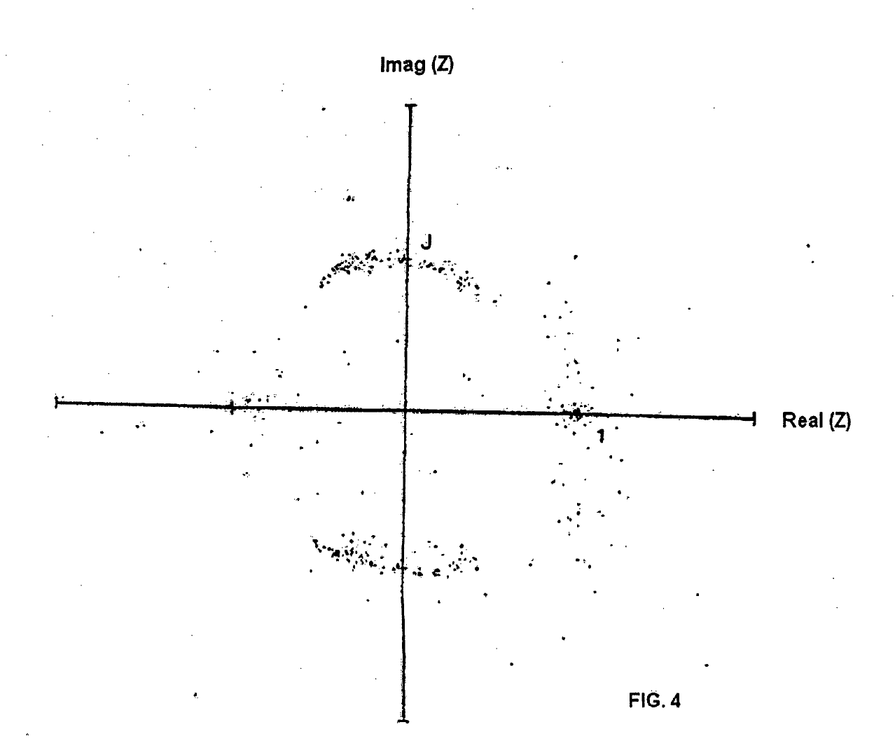

In one embodiment, the roots of polynomial comprised of Z-transformed null vector h of eigenvectors of the signal subspace are computed for three coherent signals (i.e. P=3) and eight detectors (i.e. M=8) with a signal-to-noise ratio (SNR) being 10 dB, and are represented as dots in a complex plane, as shown in FIG. 4. As shown, the dots are substantially populated at the circumference of the unit circle. Accordingly, a spatial spectrum obtained from the signal subspace can better estimate the DOA for coherent signals.

By directly using the signal subspace (DUSS), one obtains the spatial spectrum of the DOA,

$${P}_{DUSS} ( θ ) = \frac{1}{1 - {\sum }_{i = 1}^{n} {\underline{a}}_{l}^{H} ( θ ) {E}_{m c} {E}_{m c}^{H} {\underline{a}}_{l} ( θ )} , \qquad Equation 26$$

where E_{mc} denotes a signal subspace matrix, which comprises a plurality of columns corresponding to eigenvectors vₖ(l) of non-zero eigenvalues, and aₗ(θ) is the directional vector of Equation 21. Moreover,

$${\sum }_{i = 1}^{n} {\underline{a}}_{l}^{H} ( θ ) {E}_{m c} {E}_{m c}^{H} {\underline{a}}_{l} ( θ ) = {d}^{2} ( θ )$$

is a Euclidean distance between the signal subspace (E_{mc}) and directional vector aₗ(θ).

In order to suppress noise signals detected by linear detector array 110 from directions other than the DOA, one may employ weighting vector w(k) in Equation 20 to give more weight to spectral density matrix Sₗ at the DOA, and to give less weight to Sₗ at directions other than the DOA. Using a minimum variance method, weighting vector w(k) may be obtained by taking the minimum of w^{H}(k)Rₖw(k) subject to a constraint (e.g., Lagrange multiplier) of aₖ^{H}(θ₁)w(k)=1, where θ₁ is a target angle of signal source 11, and Rₖ is the covariance matrix defined in Equation 19. Accordingly, one can compute for weighting vector w(k) by using Equation 27, i.e.

$$w ( k ) = \frac{{R}_{k}^{- 1} {a}_{k} ( {θ}_{1} )}{{a}_{k}^{H} ( {θ}_{1} ) {R}_{k}^{- 1} {a}_{k} ( {θ}_{1} )} . \qquad Equation 27$$

Once weighting vector w(k) of Equation 27 is computed, one may compute a noise reduced input signal in frequency domain xₖ by multiplying weighting vector w(k) to an input signal in frequency domain yₖ, i.e.

xₖ=w(k)yₖ, Equation 28

where input signal in frequency domain yₖ is the Fourier transformed input signal yᵢ(t) of Equation 1. Consequently, a noise reduced input signal xᵢ(t) may be obtained by performing inverse Discrete Fourier Transform (DFT) on noise reduced input signal in frequency domain xₖ. Accordingly, noise reduced input signal xᵢ(t) is transmitted to a receiver. Because those signals entering linear detector array 110 at directions other than the DOA are significantly suppressed in noise reduced input signal xᵢ(t), the receiver may receive only desired signals intended to be transmitted. Therefore, audio signals of high quality may be transmitted from a transmitting party to a receiving party via a communication apparatus including linear detector array 110. In one embodiment, the communication apparatus may include a portable communication device, such as a cellular phone, or the like.

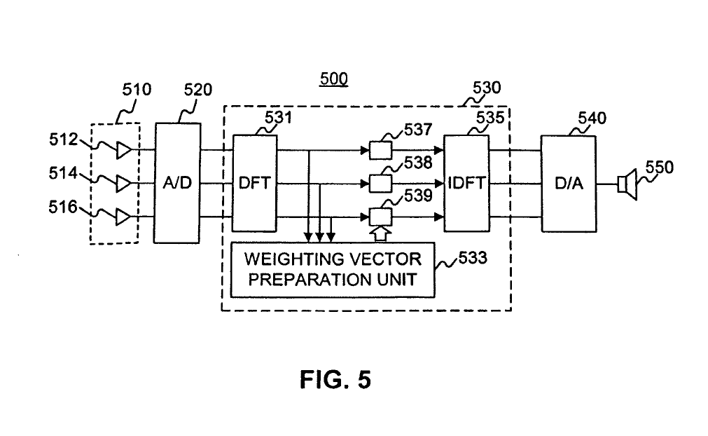

Referring to FIG. 5, a noise reduction system 500, in accordance with one embodiment consistent with the invention, will be described in detail. As shown, noise reduction system 500 may include an input unit 510, a first converter 520, and a signal processor 530. Noise reduction system 500 may further include a second converter 540, and an output unit 550.

In one embodiment, input unit 510 may include a linear detector array having a first detector 512, a second detector 514, and a third detector 516. Input unit 510 detects analog signals at a plurality of time snaps, thereby constructing analog signals in time domain. In one embodiment, detectors 512, 514, and 516 may be audio detectors, or microphones, and the analog signals may be audio signals. In one embodiment, first detector 512, second detector 514, and third detector 516 are linearly arranged and equally spaced between each other. Although three detectors 512, 514, and 516 are shown in FIG. 5, it is to be understood that input unit 510 may include an arbitrary number of detectors. It is also to be understood that detectors 512, 514, and 516 may include antennas, and the analog signals may include electromagnetic radiation signals.

As shown in FIG. 5, first converter 520 is coupled with input unit 510 for receiving the analog signals in time domain and transforming the analog signals in time domain into digital signals in time domain. In one embodiment, first converter 520 may be an analog-to-digital (A/D) converter, such as a four channel A/D converter or a two channel stereo codec, and may have a sampling rate of about 16 kHz.

Signal processor 530 is coupled with first converter 520 for receiving the converted digital signals in time domain. Signal processor 530 converts the digital signals in time domain into digital signals in frequency domain, and suppresses noise in the digital signals in frequency domain by multiplying a weighting vector to the digital signals in frequency domain to obtain noise reduced digital signals in frequency domain. In one embodiment, signal processor 530 may include a commercially available digital signal processor (DSP), such as Ti DSP 6713, manufactured by Texas Instruments Inc., etc. It is appreciated that signal processor 530 may further convert the noise reduced digital signals in frequency domain into noise reduced digital signals back in time domain.

Signal processor 530 may include a transformation unit 531, a weighting vector preparation unit 533, a plurality of multipliers 537, 538, and 539, and an inverse transformation unit 535 to perform the above functionalities.

For example, signal processor 530 may include transformation unit 531 for converting the digital signals in time domain into digital signals in frequency domain. In one embodiment, transformation unit 531 may perform a discrete Fourier transformation (DFT) on the digital signals in time domain.

Signal processor 530 may also include weighting vector preparation unit 533. Weighting vector preparation unit 533 receives the digital signals in frequency domain and computes the weighting vector according to the received digital signals in frequency domain.

More specifically, weighting vector preparation unit 533 constructs a plurality of snapshot vectors from the received digital signals in time domain according to Equation 18, and constructs a covariance matrix from the snapshot vectors according to Equation 19. Weighting vector preparation unit 533 then computes a spectral density matrix according to Equation 20, and eigen-decomposes the spectral density matrix to obtain eigenvectors and eigenvalues of the spectral density matrix. Using the eigenvectors and the eigenvalues of spectral density matrix, weighting vector preparation unit 533 may decompose the spectral density matrix into a signal subspace and a noise subspace. The signal subspace may include eigenvectors of the spectral density matrix corresponding to non-zero eigenvalues. The noise subspace may include eigenvectors of the spectral density matrix corresponding to zero eigenvalues. By directly using the signal subspace, weighting vector preparation unit 533 may compute a spatial spectrum according to Equation 26, thereby precisely estimating the DOA. Furthermore, weighting vector preparation unit 533 prepares a weighting vector based on the DOA. In one embodiment, the weighting vector gives more weight to analog signals, or maximize gain of analog signals, at incident angles adjacent to the DOA, and gives less weight to analog signals, or minimize gain of analog signals, at incident angles away from the DOA.

Once the weighting vector is computed, weighting vector preparation unit 533 transmits the weighting vector to multipliers 537, 538, and 539, so as to multiply the weighting vector to the digital signals in frequency domain. The multiplication of weighting vector and the digital signals in frequency domain gives rise to noise reduced digital signals in frequency domain. It is appreciated that, in one embodiment, the noise reduced digital signals in frequency domain may be ready to be transmitted to a receiving party.

In one embodiment, signal processor 530 may include inverse transformation unit 535 for receiving the noise reduced digital signals in frequency domain and converting the noise reduced digital signals in frequency domain into the noise reduced digital signals in time domain. In one embodiment, inverse transformation unit 535 performs an inverse discrete Fourier transformation (IDFT) on the noise reduced digital signals in frequency domain to obtain the noise reduced digital signal in frequency domain. The noise reduced digital signals in time domain may be ready to be transmitted to a receiving party.

As shown in FIG. 5, noise reduction system 500 may further include second converter 540, which is coupled with signal processor 530. Second converter 640 receives the noise reduced digital signals in time domain and transforms the noise reduced digital signals in time domain into noise reduced analog signals in time domain. In one embodiment, second converter 540 may be a digital-to-analog (D/A) converter. The noise reduced analog signals in time domain may be ready to be transmitted to a receiving party.

Further, noise reduction system 500 may include output unit 550, which is coupled with second converter 540. Output unit 550 receives the noise reduced analog signals in time domain and outputs the noise reduced analog signals in time domain. In one embodiment, output unit 550 includes a speaker.

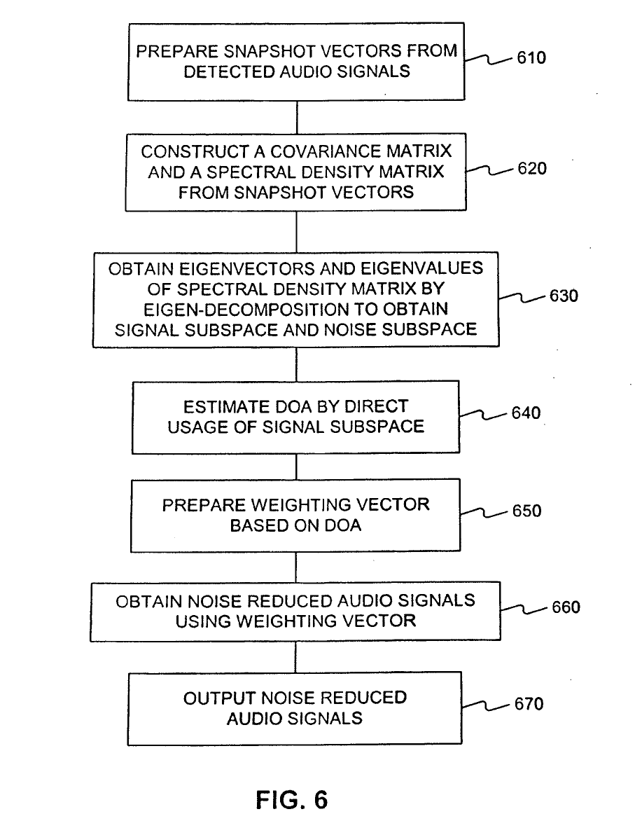

Referring now to FIG. 6, a noise reduction process, in accordance with one embodiment consistent with the invention, will be described in detail. The noise reduction process may be used to suppress noise in audio signals detected by a linear microphone array.

In Step 610, a plurality of snapshot vectors is prepared from the audio signals detected by the linear microphone array. The snapshot vectors are given in Equation 18. In one embodiment, the audio signals include multiple wide-band audio signals and/or coherent audio signals in a multipath environment with a low signal-to-noise ratio. The linear microphone array detects the audio signals at a plurality of time snaps. The detected audio signals are audio signals in time domain. The audio signals may be transformed into frequency domain using Discrete Fourier Transform (DFT) for further processing.

In Step 620, a covariance matrix is constructed from the snapshot vectors, and a spectral density matrix is constructed from the covariance matrix. The covariance matrix is given in Equation 19, and the spectral density matrix is given in Equation 20. The spectral density matrix may include a weighting vector. The weighting vector may be determined by using any appropriate method, such as a minimum variance method.

In Step 630, the spectral density matrix is eigen-decomposed to obtain a plurality of eigenvectors and a plurality of eigenvalues. The eigenvectors corresponding to non-zero eigenvalues are employed to construct a signal subspace. On the other hand, the eigenvectors corresponding to zero eigenvalues are employed to construct a noise subspace.

In Step 640, DOA of the audio signals are estimated by a spatial spectrum derived from directly using the signal subspace. In one embodiment, the spatial spectrum is given in Equation 26, which is determined according to a Euclidean distance between the signal subspace and a directional vector.

In Step 650, a weighting vector is prepared based on the DOA using a minimum variance method. In one embodiment, the weighting vector may give more weight at the DOA, and give less weight at directions other than the DOA.

In Step 660, noise reduced audio signals are obtained by using the weighting vector. In one embodiment, the weighting vector may be multiplied to the audio signals in frequency domain to obtain noise reduced audio signals in frequency domain. The noise reduced audio signals in frequency domain are then transformed into time domain by using inverse DFT, thereby obtaining noise reduced audio signals in time domain.

In Step 670, the noise reduced audio signals in time domain are output to a receiver. Accordingly, the receiver may receive audio signals with a significant reduction of noise.

A computer simulation of the above described noise reduction process has also been performed. In one example, the computer simulation considers eight omni-directional detectors, each detector being linearly arranged and equally spaced between each other. The detectors have same gain with same frequency characteristics. In this example, the computer simulation computes the spectral density matrix given in Equation 20 by considering 400 snapshot vectors with 20 time lags, i.e. n=20, and a Hamming window.

The computer simulation considers three signal sources, each including an additional white Gaussian noise passed through a band pass filter. In this example, the signal sources are delayed by an array spacing parameter f₀D/c that is substantially equal to five (i.e. f₀D/c=5). Accordingly, the signal sources can be represented as follows:

$$\begin{matrix}\frac{1}{1 + 0.371 {Z}^{- 1} + 0.36 {Z}^{- 2}} ; & Source 1 \\ \frac{1}{1 + 0.433 {Z}^{- 1} + 0.49 {Z}^{- 2}} ; and & Source 2 \\ \frac{1}{1 + 0.994 {Z}^{- 1} + 0.64 {Z}^{- 2}} . & Source 3\end{matrix}$$

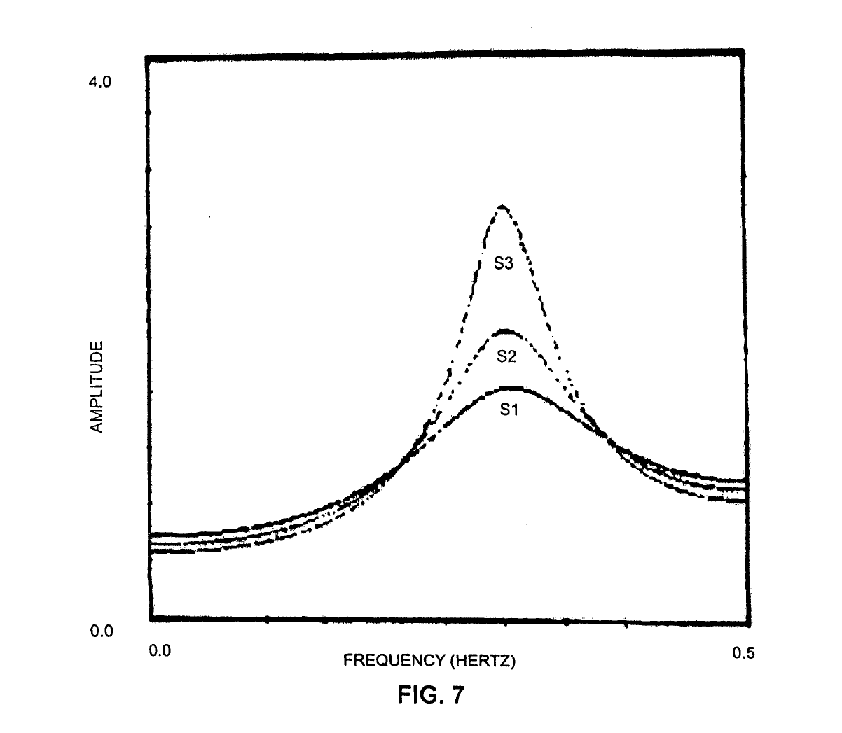

In this example, source 1 inputs signals from a first incident angle θ₁ at θ₁=−10°; source 2 inputs signals from a second incident angle θ₂ at θ₂=0°; and source 3 inputs signals from a first incident angle θ₃ at θ₃=+10°. The amplitudes of sources 1-3 in frequency domain are illustrated in FIG. 7.

Here, sources 1-3 generate signals of the same power with center frequency at 0.3 Hz. The spectra of sources 1-3 may be overlapped with each other. In the computer simulation, the signal-to-noise ratio (SNR), which is defined as a ratio between a dispersion of signals and a dispersion of noise, is considered to be zero. The DC component (l=0) of the spectral density matrix is eliminated from computation, because it does not affect the computation of spatial spectrum for omni-directional detectors.

In the computer simulation, one considers a correlation coefficient Y_{xy}, which is defined as Y_{xy}=σ_{xy}/(σₓσ_{y}), where σ_{xy} is a covariance of x and y, and σₓ and σ_{y} are variances of x and y, respectively.

In a first case, the computer simulation considers a covariance algorithm with correlation coefficient Y_{xy}=0.585, and computes the spatial spectrum according to Equation 17. The dimension of the signal subspace is four, and the correlation matrix of the white Gaussian noise is given as follows:

$$[ \begin{matrix}1 & 0.585 & 0.585 \\ 0.585 & 1 & 0.585 \\ 0.585 & 0.585 & 1\end{matrix} ] .$$

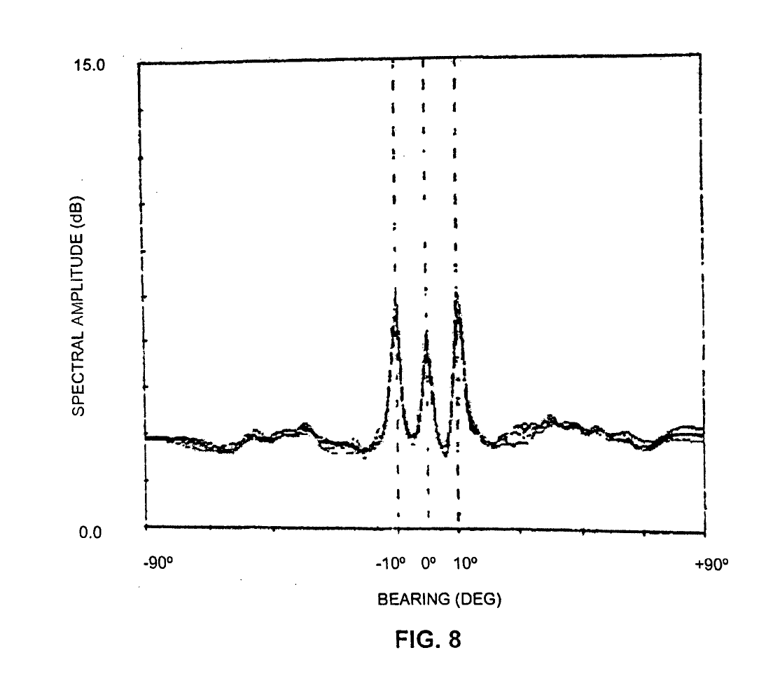

The resultant spatial spectrum in the first case is illustrates in FIG. 8. Because signals in the first case are weakly correlated, the covariance algorithm that uses Equation 17 to compute the spatial spectrum may be sufficient to precisely estimate the DOA.

In a second case, the computer simulation considers a covariance algorithm with correlation coefficient Y_{xy}=0.9, and computes the spatial spectrum according to Equation 17. The dimension of the signal subspace is four, and the correlation matrix of the white Gaussian noise is given as follows:

$$[ \begin{matrix}1 & 0.9 & 0.9 \\ 0.9 & 1 & 0.9 \\ 0.9 & 0.9 & 1\end{matrix} ] .$$

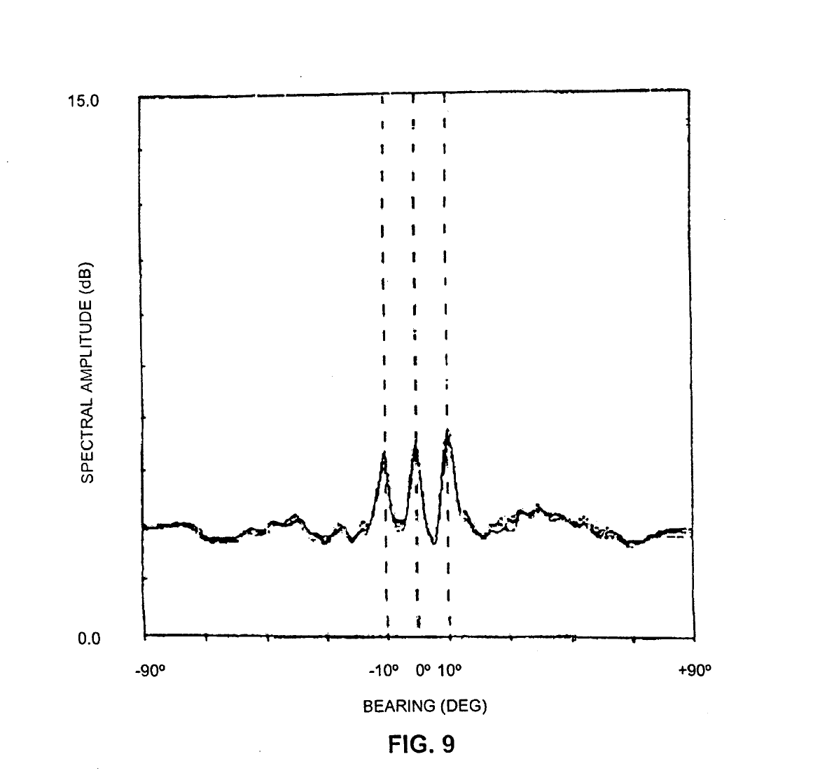

In the second case, signals are more correlated than signals in the first case, because correlation coefficient Y_{xy} in the second case is greater than that in the first case. Accordingly, signals in the second case may be referred to as being intermediately correlated. The resultant spatial spectrum in the second case is illustrated in FIG. 9. As shown, the DOA of sources 1-3 are still clearly distinguishable in the spatial spectrum. However, the amplitudes of spatial spectrum at the DOA has been significantly reduced.

In a third case, the computer simulation considers first a covariance algorithm with correlation coefficient Y_{xy}=1.0, and computes the spatial spectrum according to Equation 17. The correlation matrix becomes

$$[ \begin{matrix}1 & 1 & 1 \\ 1 & 1 & 1 \\ 1 & 1 & 1\end{matrix} ] .$$

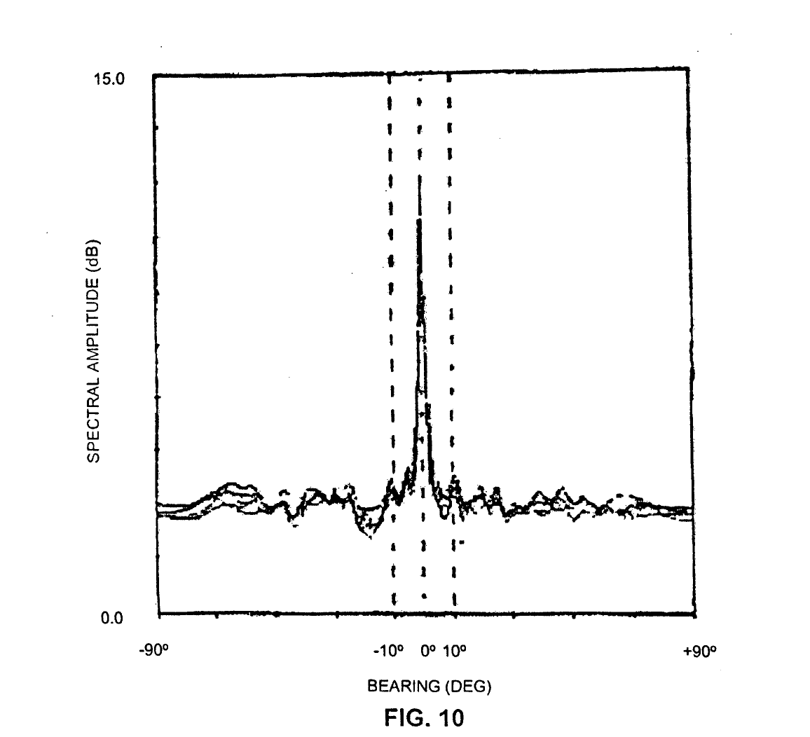

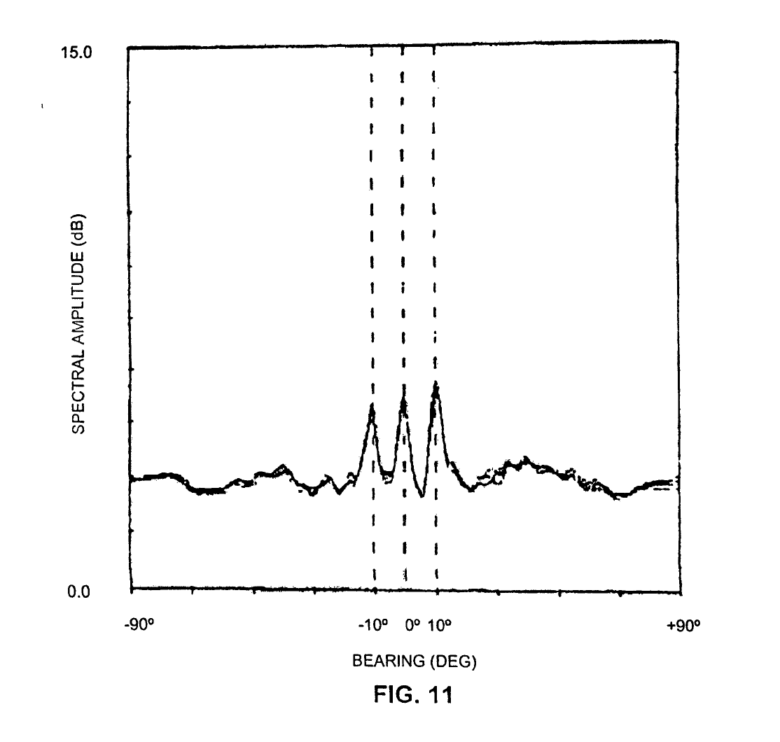

The third case represents a multi-path environment, where inputted signals are coherent signals. As shown in FIG. 10, the DOA of sources 1-3 are no longer distinguishable in the spatial spectrum. However, under the same conditions, the computer simulation computes once again for the third case the spatial spectrum according to Equation 26 by directly using the signal subspace. The resultant spatial spectrum according to Equation 26 is illustrated in FIG. 11. As shown in FIG. 11, the DOA are now clearly distinguishable in the spatial spectrum. Accordingly, the computer simulation has demonstrated that the spatial spectrum of Equation 26 can precisely estimate the DOA of coherent signals and/or signals in multipath environment.

Other embodiments consistent with the invention will be apparent to those skilled in the art from consideration of the specification and practice of disclosures provided herein. It is intended that the specification be considered as exemplary and explanatory only, with the scope and spirit of the invention being indicated by the following claims.

What is claimed is:

1. A noise reduction system, comprising:
an input unit including a linear detector array for detecting analog signals at a plurality of time snaps, thereby constructing analog signals in time domain;
a first converter coupled with the input unit, the first converter receiving the analog signals in time domain and transforming the analog signals in time domain into digital signals in time domain; and
a signal processor coupled with the first converter for receiving the digital signals in time domain, the signal processor further comprising:
a transformation unit for converting the digital signals in time domain into digital signals in frequency domain; and
noise suppressing unit configured to suppress noise in the digital signals in frequency domain by multiplying a weighting vector to the digital signals in frequency domain to obtain noise reduced digital signals in frequency domain.

2. The system of claim 1, wherein:
the signal processor further comprises an inverse transformation unit for receiving the noise reduced digital signals in frequency domain and converting the noise reduced digital signals in frequency domain into noise reduced digital signals in time domain.

3. The system of claim 2, further comprising:
a second converter coupled with the signal processor, the second converter receiving the noise reduced digital signals in time domain and transforming the noise reduced digital signals in time domain into noise reduced analog signals in time domain.

4. The system of claim 3, wherein:
the second converter comprises an digital-to-analog converter.

5. The system of claim 3, further comprising:
an output unit for outputting the noise reduced analog signals in time domain.

6. The system of claim 5, wherein:
the output unit comprises a speaker.

7. The system of claim 1, wherein:
the linear detector array includes a plurality of detectors, the detectors being linearly arranged and equally spaced among one another.

8. The system of claim 7, wherein:
the detectors comprise a plurality of microphones, and the analog signals comprise audio signals.

9. A communication apparatus, comprising:
the system as recited in claim 8.

10. The system of claim 7, wherein:
the detectors comprise antennas, and the analog signals comprise electromagnetic radiation signals.

11. The system of claim 1 wherein:
the first converter comprises an analog-to-digital converter having a sampling rate of about 16 KHz.

12. The system of claim 1, wherein:
the transformation unit performs discrete Fourier transform, and the inverse transformation unit performs inverse discrete Fourier transform.

13. The system of claim 1, wherein:
the noise suppressing unit further comprises a weighting vector preparation unit, the weighting vector preparation unit computes the weighting vector based on directions of arrival (DOA) estimated by using a spatial spectrum of the analog signals.

14. The system of claim 13, wherein:
the weighting vector preparation unit computes the spatial spectrum by directly using a signal subspace, the signal subspace being decomposed from a spectral density matrix.

15. The system of claim 14, wherein:
the weighting vector preparation unit computes the spectral density matrix based on a covariance matrix constructed from a plurality of snapshot vectors of the digital signals in time domain.

16. The system of claim 1, wherein:
the noise suppressing unit further comprising a plurality of multipliers for multiplying a weighting vector to the digital signals in frequency domain to obtain noise reduced digital signals in frequency domain.

17. A signal processor, comprising:
a transformation unit configured to receive digital signals in time domain, the digital signals corresponding to a plurality of analog signals detected by a linear detector array, and to convert the digital signals in time domain into digital signals in frequency domain; and
a noise suppression unit configured to receive the digital signals in frequency domain and suppress noise in the digital signals in frequency domain to obtain noise reduced digital signals in frequency domain, the noise reduced digital signals being obtained by multiplying a weighting vector with the digital signals in frequency domain.

18. The signal processor of claim 17, further comprising:
an inverse transformation unit for converting the noise reduced digital signals in frequency domain into noise reduced digital signals in time domain, and outputting the noise reduced digital signals in time domain for further processing.

19. The signal processor of claim 17, wherein:
the noise suppression unit is further configured to:
construct a plurality of snapshot vectors based on the digital signals in time domain;
construct a spectral density matrix based on a covariance matrix defined according to the snapshot vectors;
decompose the spectral density matrix into a signal subspace and a noise subspace;
estimate directions of arrival by using a spatial spectrum obtained by directly using the signal subspace; and
compute the weighting vector based on the directions of arrival.

20. The signal processor of claim 19, wherein:
the noise suppression unit maximizes gain of the digital signals in frequency domain at the directions of arrival (DOA) by using the weighting vector.

21. The signal processor of claim 19, wherein:
the noise suppression unit minimizes gain of the digital signals in frequency domain at directions other than the directions of arrival (DOA) by using the weighting vector.

22. A communication apparatus, comprising:
the signal processor of claim 19.

23. A method for reducing noise in audio signals detected by a linear microphone array, comprising:
preparing a plurality of snapshot vectors of the audio signals;
constructing a covariance matrix from the snapshot vectors, and constructing a spectral density matrix from the covariance matrix;
eigendecomposing the spectral density matrix to obtain a plurality of eigenvectors and a plurality of eigenvalues, thereby obtaining a signal subspace and a noise subspace;
estimating directions of arrival of the audio signals by a spatial spectrum derived from directly using the signal subspace;
preparing a weighting vector based on the directions of arrival;
obtaining noise reduced audio signals using the weighting vector; and
outputting the noise reduced audio signals.

24. The method of claim 23, wherein the audio signals include multiple wide band signals.

25. The method of claim 23, wherein the audio signals include coherent signals in a multipath environment.

26. The method of claim 23, further comprising:
transforming the audio signals into audio signals in frequency domain.

27. The method of claim 26, wherein obtaining the noise reduced audio signals further comprises:
multiplying the weighting vector with the audio signals in frequency domain to obtain noise reduced audio signals in frequency domain.

28. The method of claim 27, further comprising:
transforming the noise reduced audio signals in frequency domain to obtain the noise reduced audio signals in time domain.

29. The method of claim 23, further comprising:
obtaining a Euclidean distance between the signal subspace and a directional vector.

30. The method of claim 29, wherein:
the spatial spectrum P_{DUSS}(θ) is given as
$${P}_{DUSS} ( θ ) = \frac{1}{1 - {d}^{2} ( θ )} ,$$
where θ is an angle corresponding to the directions of arrival (DOA), and d(θ) is the Euclidean distance between the signal subspace and the directional vector.

31. The method of claim 23, wherein:
the eigenvalues includes non-zero eigenvalues and zero eigenvalues.

32. The method of claim 31, wherein:
the signal subspace comprises the eigenvectors that correspond to non-zero eigenvalues, and the noise subspace comprises the eigenvectors that correspond to zero eigenvalues.

33. The method of claim 23, wherein:
the weighting vector is prepared using a minimum variance method.
